(19) United States
(12) Patent Application Publication
(10) Pub. No.: US 2025/0304097 A1
(43) Pub. Date: Oct. 2, 2025

(54) ASSISTANCE METHOD AND SYSTEM INCLUDING DISPLAY OF VIRTUAL REPRESENTATIONS OF OBJECTS IN THE ENVIRONMENT

(71) Applicant: Honda Research Institute Europe GmbH, Offenbach/Main (DE)

(72) Inventor: Chao Wang, Offenbach (DE)

(73) Assignee: Honda Research Institute Europe GmbH, Offenbach/Main (DE)

(21) Appl. No.: 19/237,006

(22) Filed: Jun. 13, 2025

Related U.S. Application Data
(63) Continuation-in-part of application No. 17/365,983, filed on Jul. 1, 2021.

(30) Foreign Application Priority Data
Jul. 3, 2020 (EP) 20183897.6

(51) Int. Cl. B60W 50/14; B60K 35/28

(52) U.S. Cl. CPC B60W 50/14; B60K 35/285; B60K 2360/149; B60K 2360/1868; B60K 2360/188; B60K 2360/31; B60K 2360/334; B60W 2050/146

(57) ABSTRACT

The invention regards an assistance system and a method for assisting a user of such an assistance system including a display displaying representations of one or more objects in the environment of the display. In a first step, information on an environment of the display, is determined and presence of objects in the environment is determined. Then, a representation of the environment including representations of the objects determined in the environment is generated. For at least one of the determined and displayed objects, a starting point for an indicator line is calculated from a direction of the object relative to the display, and, for each determined starting point, an indicator line connecting the starting point with the displayed representation of the real world object is drawn.

### CROSS-REFERENCE TO RELATED APPLICATIONS

This application is a continuation-in-part of and claims the benefit of U.S. patent application Ser. No. 17/365,983, filed on Jul. 1, 2021, which claims the priority benefit of European patent application serial no. 20183897.6, filed on Jul. 3, 2020. The entirety of each of the above-mentioned patent applications is incorporated by reference herein and made a part of this specification.

### TECHNICAL FIELD

The invention regards a method for assisting a user of an assistance system in perceiving an environment and a respective assistance system, in particular an advanced driver assistance system of a vehicle.

### BACKGROUND

In order to improve safety for traffic participants, a large variety of assistance systems has been developed over the last years. The systems usually use sensors for physically sensing the environment of the system, for example, the environment of a vehicle. In order to assist the user, the systems generate a representation of the environment. In many cases, the systems are designed to generate behavior suggestions based on the representations. Other approaches are only intended to improve the environment perception by the user. These systems display the environment representations by displaying objects that are sensed in the environment of the display, which is held by the user or mounted on a vehicle that is operated by the user. Often, sensed objects or related information is displayed using augmented reality displays. Such approaches are, for example, known from U.S. Pat. No. 9,690,104 or EP 3570225 A1.

### SUMMARY

One problem of the known systems is that the user, unless the system is designed for fully automated driving, still needs to observe the environment himself. Even in level 2 automated systems, the driver still needs to observe the surroundings and the status of the vehicle in case of abnormal situations. Thus, adding additional information to what the user needs to perceive in the environment anyway, will lead to an increased amount of information. Perceiving details of the environment that are necessary to take the correct decisions for safely participating in a dynamic environment such as dense traffic is a demanding task. Thus, simply adding information that additionally needs to be perceived by the user may even cause distraction of the user and, thus, may rather be detrimental to the desired effect of improving safety.

It is to be noted that the problem is not limited to assistance systems where a driver necessarily needs to align the real-world with representations on a display. Event navigation systems can use sensed outside information to enhance the realistic impression which automatically leads to the driver, or a user of such a system in general, trying to identify real-world objects with the corresponding representations on the display. It is thus an object of the present invention to alleviate perception of the environment of the user by indicating a correspondence between objects in the environment (real-world objects) of the assisted user which are included as icons in the representation used in the assistance system.

This object is achieved by the method according to the invention, the assistance system and a corresponding vehicle including such an assistance system.

According to the invention, the method for assisting a user of an assistance system including a display displaying one or more icons corresponding to (or images of) objects in the environment of the display at first obtains information on an environment of the display, which is the environment of the vehicle in case that the display is mounted on the vehicle. Presence of objects in the environment is determined using sensors and a representation of the environment including the objects determined in the environment is displayed on the display. Then, a starting point for an indicator line is determined from a direction of the object relative to the display for at least one of the determined and displayed objects. Finally, for each determined starting point, the indicator line connecting the starting point with the displayed object is displayed. The inventive assistance system comprises a display, respective sensors and a processing unit that is configured to carry out the method steps explained above.

The general idea of the present invention is that a user of an assistance system will easily recognize information on the environment which is displayed of the display, when the user can easily identify objects in the environment of the display with respective icons (images) as representations of the objects on the display. Consequently, the time needed by the user to align the information perceived directly from observing the environment and information given by the display is reduced. This results in a user's improved understanding of the overall situation and, in the end, reduces errors that are made by the user. In case that such an assistance system is dedicated to assist a person participating in traffic, for example, when operating a vehicle in which such an assistance system is mounted, this will leads to increased safety.

The dependent claims define advantageous embodiments of the method and assistance system.

In the method according to an embodiment, the reference point of the display corresponds to a center of the display, a representation of the user displayed by the display, a center of an ego-vehicle, or an eye location of the user in the coordinate system of the display.

The embodiments of the method provide a framework for generating a presentation of the current scenario in the environment, which enables to use a wide variety of reference points for coordinate transformations between the real world and the display, and different locations for the display in relation to the user viewing the display.

According to one preferred embodiment, the starting point is calculated as a point of intersection between an outer edge of the display and a surface area extending from a vertical axis through a reference point of the display and including a direction vector pointing from the reference point towards the real world object for which the indicator line shall be displayed. Identifying a starting point and displaying an indicator line as explained above allows the user to intuitively identify the objects in the real world in the environment of the vehicle with the corresponding object representations (icons, images) on the display. Having the starting point located at the edge of the display in a very intuitive manner combines the real world objects with the representation on the display. Thus, it is easily possible for the user to identify real-world objects with corresponding icons or simplified object representations on the display.

The identification of objects in the real world environment of the assistance system with the represented objects on the display is further improved when the direction vector is calculated so as to point from the reference point in the display to a center of the determined object.

Further improvement is achieved, if, for at least one determined and displayed object, an indicator bar corresponding to a perceivable horizontal extension of the determined object is displayed along the outer edge of the display, wherein the indicator bar includes the starting point. This is particularly helpful, if the indicator line itself may be ambiguous because there is a plurality of objects in the real world. The indicator bar allows to directly recognize horizontal dimensions of the object in the real world which gives the user of the assistance system a further indication of a correspondence between the real world object and its representation on the display.

In the method according to an exemplary embodiment, the indicator bar includes a visual characteristic for indicating a determined characteristic of the at least one object.

The visual characteristic of the indicator bar may include at least one of a brightness, a colour, a transparency, a width, and a pattern of the indicator bar. The characteristic of the at least one object may include at least one of a size, a distance to the display, and a velocity relative to the display of the at least one object. Thus, the indicator bar can convey further information on the at least one object to the user. The assistance system may increase the situational awareness of the user in an intuitive manner.

Preferably, the indicator bar extends from a first intersection point of the edge of the display and a first boundary surface area to a second intersection point of the edge of the display and a second boundary surface area, wherein the first boundary surface area extends from the vertical axis through the reference point and includes a first direction vector pointing from the reference point towards a first outermost perceivable boundary of the determined object in the horizontal direction and the second boundary surface area extends from the vertical axis through the reference point and includes a second direction vector pointing from the reference point towards an opposite, second outermost perceivable boundary of the determined object in the horizontal direction. Since the ends of the indicator bar are defined by a first intersection point and a second intersection point, which are determined in a similar way as the starting point, it is intuitively recognized by the user like a projection of the real world objects onto the display.

In an exemplary embodiment of the method, the indicator line is an area with a width extending from the first boundary area to the second boundary area, wherein a visual characteristic of the indicator line includes a predetermined color, a gradient color or a predetermined pattern.

A design of the indicator line may thus support an intuitive understanding of the user, which object in the real world corresponds to which representation on the display. Designing the indicator line as an area may support the user in recognizing the indicator line in difficult visibility, e.g. a sunlit interior of a vehicle and when looking towards the display from angles widely differing from 90 degrees. Thus, an arrangement of the display in the interior of the vehicle has more degrees of freedoms, as the requirements for viewing angles are less restrictive.

According to an advantageous aspect and in case of coincidence of boundary surfaces of two determined objects, directly adjacent indicator bars are displayed using distinguishable characteristics. Thus, even if one of the objects in the environment of the display or the assistance system is partially occluded by another object, and both objects are displayed in the representation, the arrangement of the indicator bars having distinguishable characteristics allows easy determination which indicator bar belongs to which real-world object. It is to be noted that a horizontal extension of an occluded object is assumed to be limited by the horizontal extension of the occluding object. Thus, necessarily, in case of partially occluded objects, the rightmost surface area of the one object coincides with the leftmost surface area of the other object, or vice versa. The characteristics may particular include colors, brightness or patterns of the indicator bars.

An exemplary embodiment of the method comprises determining shapes of the representations of the objects by projecting, using an eye position of the user, a shape of each of the objects into an expanded surface including the display screen, and respectively generating the shape of the representations based on the projected shapes of the objects.

The shape, or outline, or contour of the object may therefore support the user in associating the representation of the object on the display with the object in the real world. Hence, the situational awareness of the user assisted by the assistance system may be further increased.

The method according to an exemplary embodiment further comprises steps of determining shapes of the representations of the objects located to a rear of the user by performing the steps: projecting, using a position of the user, a shape of each of the objects located to the rear into an mirrored expanded surface to generate a projected shape, wherein the mirrored expanded surface is a surface generated by mirroring the expanded surface including the display screen; mirroring the projected shape to the expanded surface including the display screen at a surface that includes the eye position of the user and is in parallel with the mirrored expanded surface and the expanded surface including the display screen to generate a first reflected shape; mirroring the first reflected shape along a horizontal axis running through a center of the display to generate a second reflected shape in the expanded surface including the display screen, and respectively generating the shape of the representations of the objects located to the rear based on the second reflected shapes of the objects located to the rear.

Thus, the computer-implemented method includes a processing capability for integrating a display of objects located to the rear of the user, in particular to the rear of an ego-vehicle mounting an assistance system according to an embodiment, into the display, thereby further increasing the area of the environment of the display, which is represented on the screen, and significantly assisting the user in grasping the current scenario in a highly dynamic environment including a plurality of dynamic objects all around the user.

The assistance system according to the invention comprises a display, controlled by a processing unit configured to obtain information on an environment of the display sensed by sensors, determine presence of objects in the environment, and to cause the display to display a representation of the environment including the objects determined in the environment, and to determine for at least one of the determined and displayed objects, a starting point for an indicator line from a direction of the object relative to the display, and to cause the display to display, for each determined starting point, the indicator line connecting the starting point with the representation of the object.

In case that additionally indicator bars shall be displayed, the processing unit is further configured to cause the display to display for at least one determined and displayed object an indicator bar corresponding to a perceivable horizontal extension of the determined object along the outer edge of the display, wherein the indicator bar includes the starting point.

### BRIEF DESCRIPTION OF THE DRAWINGS

Further aspects and details will now be explained with reference to the annexed drawings in which

FIG. 1 is an illustration for explaining the resulting display allowing to easily recognize the correspondence between real-world objects and their representation on the display,

FIG. 2 is a schematic for explanation of the method for defining a starting point for the indicator line,

FIG. 3 is an enlarged view of FIG. 2,

FIG. 4 is an illustration for explaining the method for defining indicator bars corresponding to real-world objects,

FIG. 5 is a simplified block diagram with the main components of the assistance system according to the invention,

FIG. 6 is a simplified flowchart detailing the method steps according to the invention,

FIG. 7 is a schematic in a top view for illustrating an exemplary embodiment of a generalized method for defining a starting point for the indicator line,

FIG. 8 is a schematic in a perspective view for the embodiment of the generalized method for defining a starting point for the indicator line,

FIG. 9 is an illustration for explaining an alternate method for defining indicator bars corresponding to real-world objects based on an eye perspective of the user,

FIG. 10 is an illustration for explaining a method for generating the indicator bar along an edge of the display,

FIG. 11 is an illustration for explaining a method for determining the display including representations for objects corresponding to real-world objects towards the back of an ego-vehicle,

FIG. 12 is an illustration of determining the display including representations for objects corresponding to real-world objects towards the back of an ego-vehicle, and

FIG. 13 is an illustration of the resulting display allowing to easily recognize the correspondence between real-world objects and their representation on the display using variations of the indicator line and the indicator bars.

### DETAILED DESCRIPTION

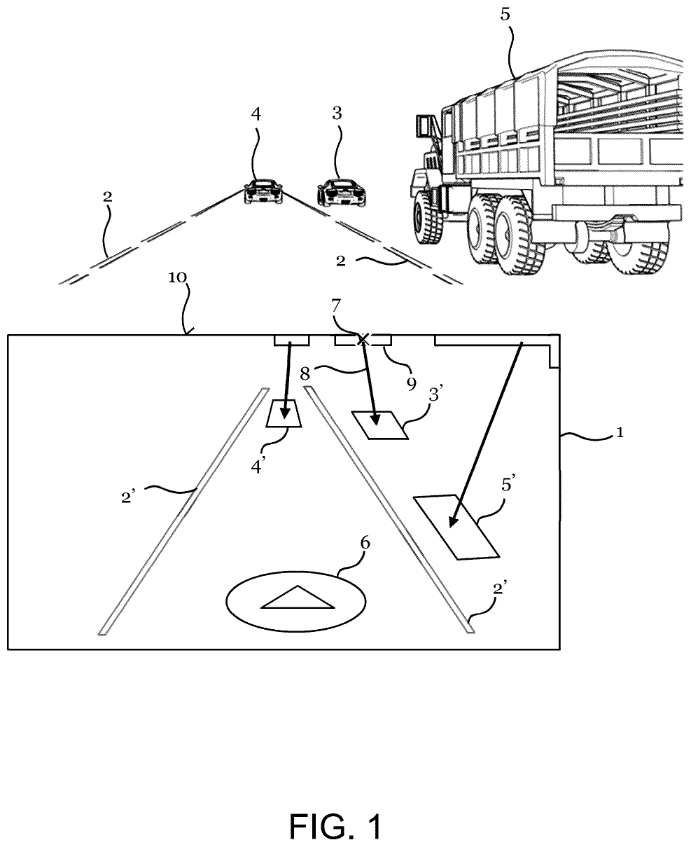

FIG. 1 shows a display 1, on which a representation of an environment of the display 1 is displayed. The environment of the display 1 is sensed by one or a plurality of sensors. Based thereon, a processing unit calculates the representation to be displayed from the sensor signals. Typically, such displays 1 are mounted on a vehicle, the driver of which shall be assisted in perceiving the environment and thus taking the right decisions in order to safely drive the vehicle. For the following explanations it shall be assumed that the display 1 is mounted in such a vehicle and is part of an advanced driver assistance system.

For simplicity of the drawings only the display 1 of the vehicle is shown, because vehicles comprising driver assistance systems including such displays are readily known in the art.

In the situation illustrated in FIG. 1, which is used for explaining the functioning of the inventive method and assistance system, a plurality of vehicles can be perceived in the environment of display 1. It can be gathered from FIG. 1 that the vehicle on which the display 1 is mounted is driving on a certain lane of a road, which is delimited from neighboring lanes by left and right lane markers 2.

On the right neighboring lane, a vehicle 3 can be identified and further a lorry 5 following the vehicle 3. Additionally, on the ego-lane, a further vehicle 4 is driving as a predecessor. Objects that are sensed by the sensors and determined from the sensor signals by postprocessing all the sensor signals are, of course, not limited to vehicles. There are many systems on the market available, which are capable of identifying a plurality of different objects from sensor signals. Sensors may be for example radar sensors, LIDAR sensors, ultrasonic sensors, etc. So identification of objects in signals received from respective sensors is known in the art and an explanation thereof shall be omitted for reasons of conciseness.

The explanations that are giving hereinafter refer to vehicle 3 in order not to limit in any way only to vehicles driving on the same lane as the ego-vehicle. However, the explanations given are valid in the very same way for any object, which can be determined in the environment of the display 1. It is particularly to be noted, that the following explanations all refer to vehicles, as here the advantageous aspects become immediately evident. Perception of moving objects in the environment of a traffic participant is more challenging than identification of static elements. Nevertheless, the invention is applicable for all objects that can be determined in the environment of the display 1.

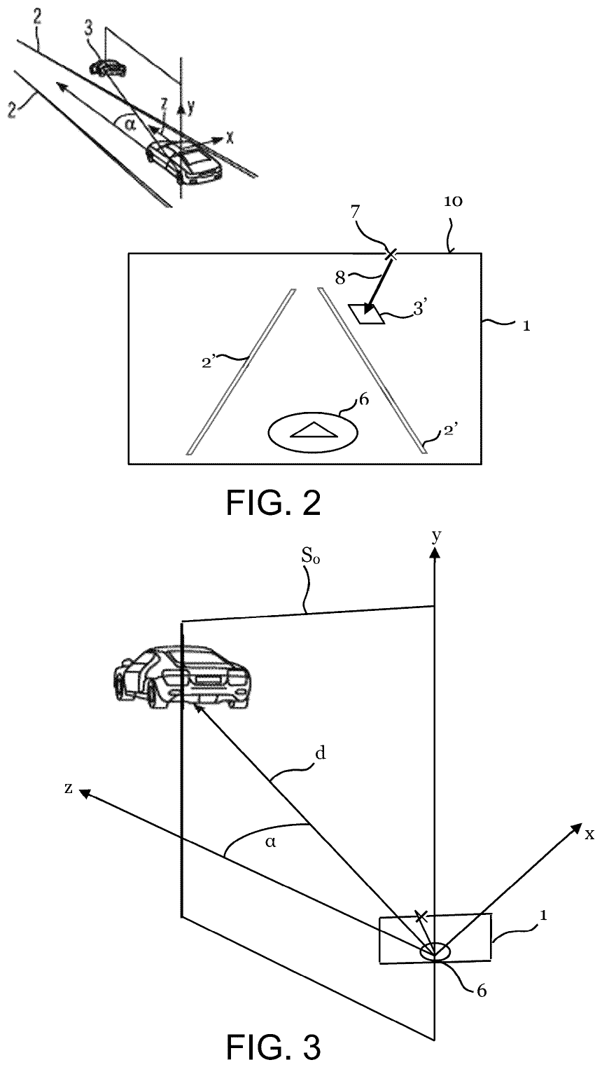

A sensor, not illustrated in FIG. 1, physically senses the environment of the vehicle and thus the environment of the display 1. From the sensor output, a processor calculates positions of the determined objects in a coordinate system, which has a fixed relation to the display 1. The fixed relation of the display 1 and the sensor to each other is known from the design of the system. Thus, no matter in which coordinate system the positions of objects in the environment are calculated, the positions may be converted into a coordinate system of the display 1. This will be explained in greater detail with reference to FIGS. 2 and 3.

From the sensor output the representation of the environment of the display 1 is calculated. Objects that can be determined from the sensor outputs are displayed as corresponding icons on the displayed 1. Depending on the resolution of the display 1 and the processing performance of the entire system it is also possible to use images representing the real world objects instead of icons. In the example illustrated in FIG. 1, the vehicles 3, 4 and the lorry 5 are shown as gray surfaces 3′, 4′ and 5′. Additionally, lane markers 2′ are shown to indicate the lane on which the ego-vehicle (and also vehicle 4) is driving. The position of the ego-vehicle is indicated by a further icon 6 including an arrow in order to indicate the driving direction of the ego-vehicle.

According to the invention, the user of the assistance system shall be assisted in identifying a correspondence between objects perceivable outside the display 1 in the real world and their corresponding icons displayed on the display 1. In the present case, this will be explained with reference to vehicle 3 as an example.

Based on the sensor output a starting point 7 is calculated by the processor (not shown in FIG. 1). The starting point 7 is calculated to lie on the edge 10 of the display 1. This starting point 7 is then connected with the icon 3′ corresponding to the real world object, namely vehicle 3, by drawing an indicator line 8. It is preferred that the indicator line 8 between the starting point 7 and the icon 3′ is an arrow with its tip ending inside the gray area of the icon 3′.

As it will be explained hereafter, the position of the starting point 7 on the edge 10 of the display 1 is determined such that the indicator line 8 resembles a direct connection from the real world vehicle 3 to the corresponding icon 3′. As it has been briefly discussed above, the position of the real world vehicle 3 in the coordinate system of the display unit 1, which is the relative position of the vehicle 3 to the display 1, is known.

In addition to the indicator line 8 an indicator bar 9 is displayed on the display 1 in a preferred embodiment. The indicator bar 9 extends along the outer edge 10 of the display 1. The length of extension along the edge 10 of the display 1 corresponds to horizontal dimension of the corresponding real-world object as this dimension is perceivable by a user of the assistance system. This means that for objects that have a greater distances to the display 1 only a shorter indicator bar 9 is displayed on the display 1. The same object being closer to the display 1 would be represented by an indicator bar 9 with larger extension.

Depending on the relative position of the real-world object to the display 1, the indicator bar 9 may extend over a plurality of edges 10 of the display 1, which, for example, may have a rectangular shape. In the illustrated embodiment, this can be seen by the indicator bar in the right upper corner of the display 1 representing the lorry 5. However, as it will be apparent from the following explanations, all calculations determining the starting points 7 and the endpoints of the indicator bars 9 refer to the same reference point on the display 1. This reference point is the center of the icon 6 and is the point at which all axes of the coordinate system intersect. The absolute orientation of the coordinate system of the display 1 is not relevant for the calculation of the starting point 7 and the indicator bar 9 as long as two conditions are fulfilled:
a) one axis has to extend in the vertical direction so that the other 2 span a horizontal plane
b) the orientation of the coordinate system is static.

For a first explanation of the inventive method, it is now referred to FIG. 2. As indicated above, the explanations are limited to a single environmental object that is sensed by the sensors, namely vehicle 3. Of course, the displayed representation of the environment in FIG. 2 is adapted such that only the icon 3′ and the lane markers 2′ are shown.

As it can be seen in FIG. 2 it is not absolutely necessary that the indicator line 8 extends to the middle of the surface of the icon 3′, but it is sufficient that it unambiguously points at towards icon 3′ to allow a user to identify the icon 3′ with the respective real-world vehicle 3.

Before the display 1 can output the screen as shown in FIG. 2, it is necessary to determine the position of the starting point 7 on the edge 10 of the display 1. This approach is explained with reference to the upper part of FIG. 2 and the enlarged portion in FIG. 3.

Vehicle 3 has mounted the assistance system of the present invention including at least one sensor allowing to determine the direction in which objects in the environment of the ego-vehicle are located. The position determination may be done in a first coordinate system which is in the present case indicated by the arrow pointing in the driving direction of the vehicle 3. With reference to this coordinate system an angle α is determined. Generally, the position and orientation of the display 1 and the coordinate system used for determining the position of the vehicle 3 have a fixed relation and, thus, the position of the vehicle 3 in the coordinate system of the displayed 1 can be easily determined. For the understanding of the present invention is sufficient to assume that the coordinate system of the sensor and the display 1 coordinate system coincide. It is to be noted, that this assumption is only made for an easy understanding and without limiting the generality.

As mentioned above, the coordinate system of the display 1 is arranged such that all 3 axes of the coordinate system run through the reference point corresponding to the ego-vehicle's position on the display 1, which is the origin of the coordinate system.

Once the direction in which the vehicle 3 is relative to the display 1 is known, a surface area S_{O} is determined extending from the vertical axis y running through the reference point of the display 1 and including a direction vector d pointing at the vehicle 3.

This surface area S_{O} intersects with display 1 and, thus, has an intersection point with one edge 10 of the display 1. In order to avoid that the surface area S_{O} has a second intersection point, the surface area S_{O} extends only from the vertical axis y in the direction of the direction vector d pointing at the real-world object, vehicle 3. The only requirement that must be fulfilled is that the display 1 and the vertical axis y intersect in one point, meaning that the vertical axis does not lie in the plane of the display 1.

Since the position of the icon 3′ is known in advance, and having now determined the position of the starting point 7 on the edge 10 of the display 1, the indicator line 8 can be drawn. For choosing the second end point of the indicator line 8 (tip of the arrow), a plurality of different approaches are possible: first, the indicator line 8 may connect the starting point 7 and the center of the area of icon 3′. Second, the indicator line 8 may extend along an intersection line of the surface area S_{O} and the display 1. This intersection line necessarily extends from the starting point 7 towards the origin of the coordinate system of the display 1. Assuming that a user of the assistance system intuitively identifies his own position with the icon 6 indicating the ego-vehicle and, thus, with the position of the reference point on the display 1, this gives the most natural approach for easily identifying objects of the real world and the environment of the display 1 with the corresponding icons. The length of the indicator line 8 may, however, be chosen based on design considerations, for example, to avoid occluding other objects. Thus, the indicator line 8 may extend to the center of the icon or may only point to the boundary of the icon area.

It is to be noted that for determining the direction vector d, well known image processing techniques may be applied. For example, from the data received from the sensors, an outline of an image of the real-world object in the environment representation can be generated, and the coordinates in the center of an area of such outline can be chosen as a tip will of the direction vector. Other alternatives may be thought of as well.

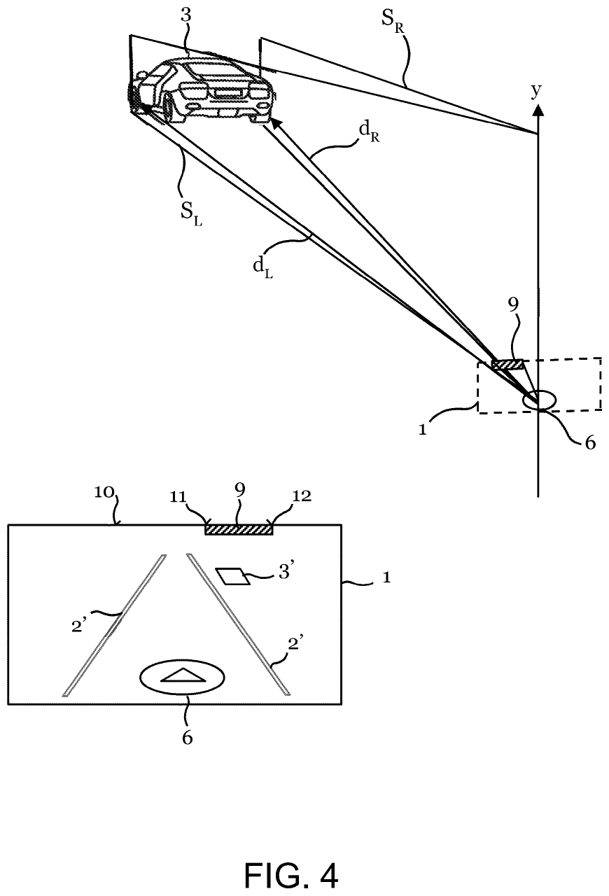

In FIG. 4, an advantageous embodiment is illustrated. In addition to the indicator line 8, an indicator bar 9 is displayed for each determined and displayed object: for example, vehicle 3, that is displayed in the representation of the environment on the display 1. For illustrative purposes, the indicator line 8 as well as the surface area Sₒ used for calculating the starting point 7 are omitted in the drawing.

For determining a first endpoint and a second end point of the indicator bar 9, intersection points 11, 12 of a first surface area S_{L} a second surface area S_{R} are determined. The calculation of the intersection points 11, 12 of the first surface area S_{L} and second surface area S_{R} with the edge 10 of the display 1 is similar to the calculation of the starting point 7 explained with reference to FIGS. 2 and 3: Again, surface areas S_{L}, S_{R} are determined based on the vertical axis y of the coordinate system of the display 1 and direction vectors d_{L}, d_{R}. This time, the direction vectors d_{L}, d_{R} point from the origin of the coordinate system of the display 1 towards a leftmost and rightmost point of the outline of the real-world object. Thus, the resulting indicator bar 9 corresponds to a extension of the real-world object in the horizontal direction.

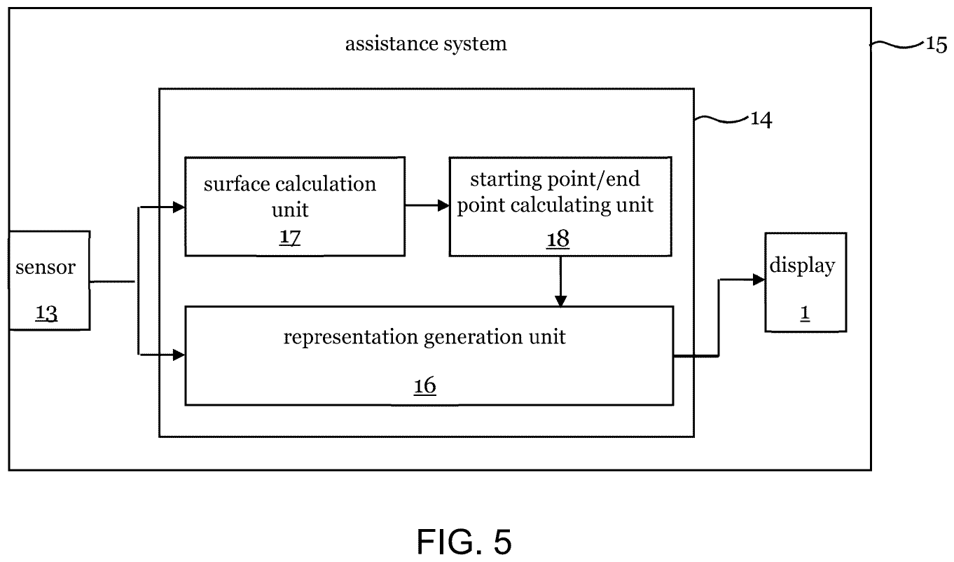

FIG. 5 shows a simplified block diagram having the display 1, one or more sensors 13 and a processor 14 as main components of the inventive assistance system 15. The assistance system 15 will usually be mounted on a vehicle and sensors 13 which are available from other assistance systems of such a vehicle may be used commonly for the different assistance systems.

The sensor output is supplied to the processor 14 which, based on information contained in the sensor signal calculates a representation of the environment in a representation generation units 16. According to the invention, and based on the sensor output too, a surface calculation unit 17 calculates one or more surface areas S_{O}, S_{L}, S_{R} as explained above and supplies the information on these surfaces to a starting point/endpoints calculating unit 18.

It is to be noted that the units 16, 17 and 18 may all be realized as software modules with the software being processed on the same processor 14. The “processor” 14 may also consist of a plurality of individual processors that are combined to a processing unit. Further, the coordinates of the display 1 in the coordinate system of the display 1 are known and stored in the assistance system 15. Thus, based on surface areas S_{O}, S_{L}, S_{R} that are defined in the surface calculation unit 17, it is easy to calculate intersections (intersection points as well as intersection lines) between these surface areas S_{O}, S_{L}, S_{R} and the surface of the display 1. It is to be noted that whenever the explanations given with respect to the present invention refer to the “display 1”, the display surface visible for a user is meant but not the entire display unit.

As it had been explained earlier already, a coordinate transformation may be made in a preprocessing step after the environment of the display 1 has been sensed by the sensors 13. Such a coordinate transformation is necessary only in case that the coordinate system used for the sensors 13 (and thus determination on the relative position of an object in the real world) and the coordinate system of the display 1 is not the same. In case that the position of the sensors 13 and the display 1 are very close, the same coordinate system may be used and conversion of the coordinates becomes unnecessary.

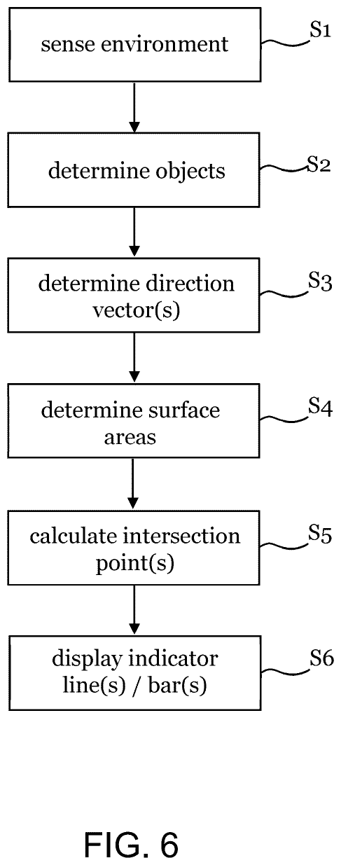

FIG. 6 shows a simplified flowchart illustrating the main method steps according to the invention, which have been explained in greater detail above.

First, using sensors, the environment of the display 1 is sensed in step S1. Next, in step S2, objects in the environment are determined from the sensor output. In step S3 direction vectors d, d_{L}, d_{R} are calculated which point to a center of the objects, or to the extrema in the horizontal direction which identify its leftmost and rightmost boundary of, for example, a traffic object.

In step S4, a surface area S_{O}, S_{L}, S_{R} is determined for each of the determined direction vectors d, d_{L}, d_{R}. These surface areas are then used in step 5 to calculate intersection points lying on the outer edge 10 of the display 1. Finally, in step S6, for each calculated starting point 7 an indicator line 8 is displayed. In case that pairs of first endpoints and second in points are calculated from the respective surface areas S_{L}, S_{R}, corresponding indicator bars 9 are displayed.

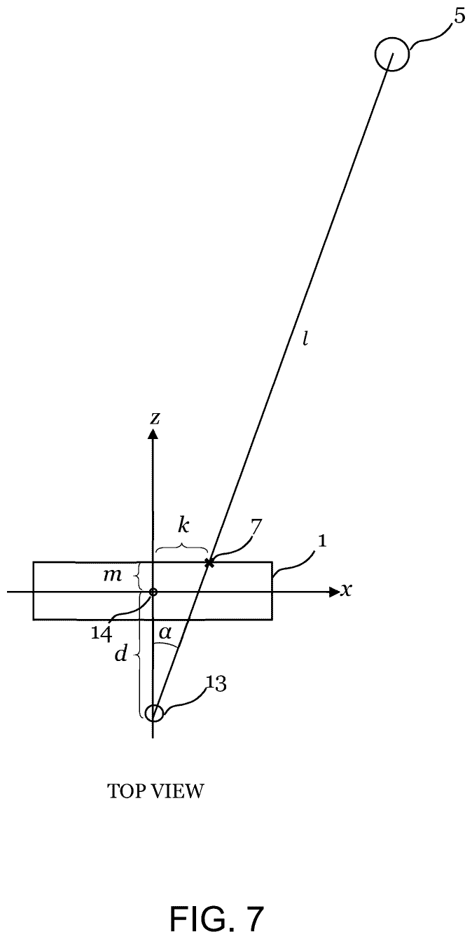

FIG. 7 is a schematic in a top view for illustrating an exemplary embodiment of a generalized method for defining a starting point 7 for the indicator line 8.

The calculation process for determining a starting point 7 for the indicator line 8 that is particularly useful when a center point 13 of the display 1 includes an offset from a viewer position.

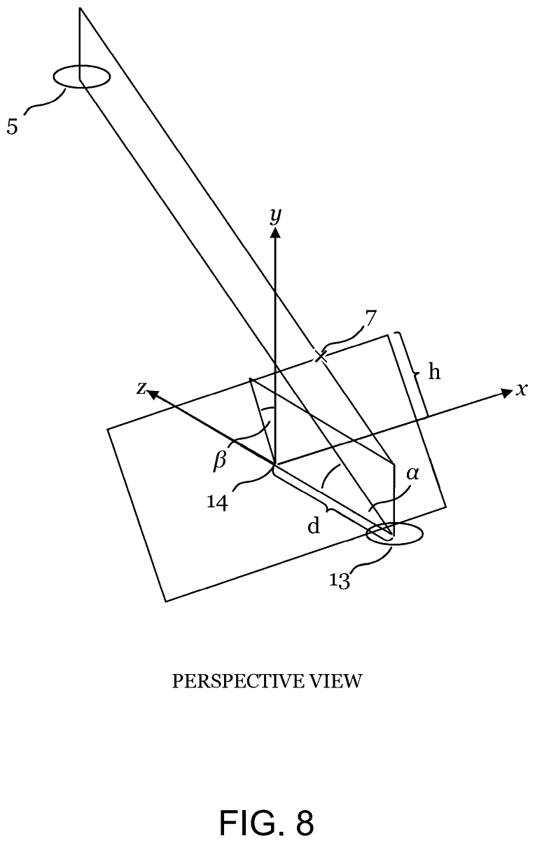

The reference point 13 of the display 1 of FIGS. 7 and 8 is externally to the screen of the display 1 and corresponds to an ego-vehicle position. A center 14 of the display 1 is set as an origin of the coordinate system used in the calculations of FIGS. 7 and 8. A distance d is between the reference point 13 and the center 14 of the display 1. The geometry of the ego-vehicle and the display 1 provides the distance d between the center point 14 of the display and the origin 14 of the coordinate system.

The system determines an angle α between a base direction z of the coordinate system and the direction of the object 5 based on the sensor data acquired from the at least one sensor.

The system determines a distance l to the object 5 from the origin of the coordinate system 13 based on the sensor data acquired from the at least one sensor.

FIG. 8 is a schematic in a perspective view for the embodiment of the generalized method for defining a starting point 7 for the indicator line 8. The display 1 shown in FIG. 8 is inclined in relation to a vertical line with a tilt angle β. Hence, using a half-height h of the display 1, the length of m is determined as

$$m = h * sind ( β ) ; \qquad ( 1 )$$

as the perspective view of FIG. 8 shows. The surface Sₒ in FIG. 8 then includes the direction 1 from the origin 14 of the coordinate system towards the object 5, and the vertical direction in the origin 14 of the coordinate system. The surface Sₒ intersects with an upper edge 10 of the display 1 in the intersection point 7. The intersection point 7 is located at a horizontal offset k from the center line of the display 1 in the y-z-surface of the coordinate system x-y-z according to

$$k = ( m + d ) * tan ( α ) ; \qquad ( 2 )$$

From expressions (1) and (2), the offset k is determined according to

$$k = ( h * sind ( β ) + d ) * tan ( α ) ; \qquad ( 3 )$$

The basic geometry of the center 13 of the ego-vehicle corresponding to the origin 13 of the coordinate system, the center 13 of the display 1 used in the calculations according to equation (3) is predetermined. The starting point 7 of the indicator line 8 may be offset from the center screen in the vehicle, a center of the ego-vehicle position and an eye position of the user. The discussed process for determining the offset k is advantageous, since it also works in cases in which the tilt angle β of the display 1 is 0 (zero). Furthermore, the user may adapt the display 1 according to his preferences, in particular, which display of the indicator line 8 supports him best for associating the representations 3′ on the display 1 and the corresponding objects 5 in the environment of the ego-vehicle.

FIGS. 7 and 8 illustrate processes for determining the starting point 7 at the edge of the 10 for the indicator line 8. Calculating a position and length for the bar 9 along the edge of the display 1 may be performed based on a position and viewing direction (perspective) of the eye of the user.

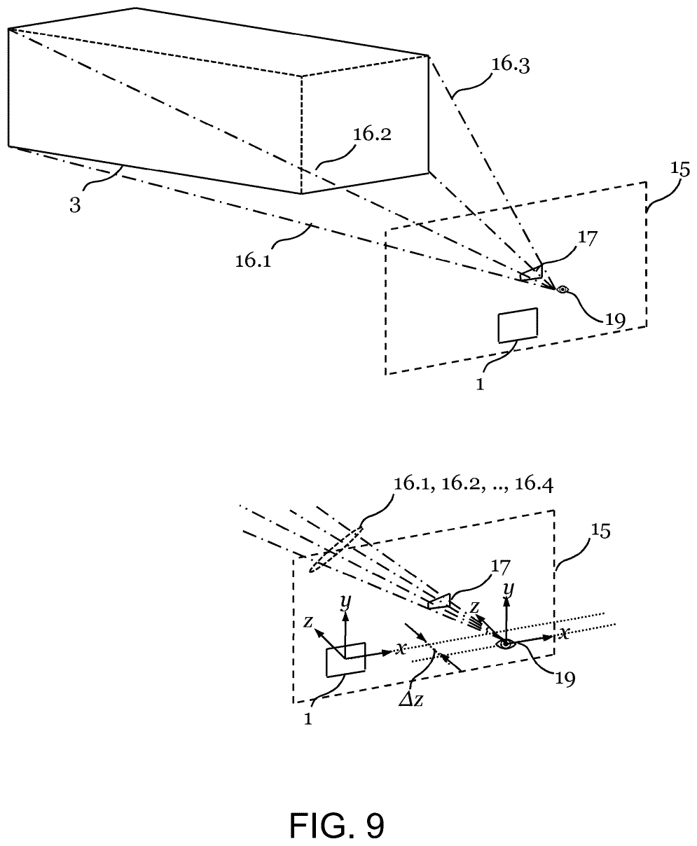

FIG. 9 is an illustration for explaining an alternate method for defining indicator bars corresponding to real-world objects 5 based on an eye perspective of the user. In FIG. 9, the display 1 and an expanded surface area 15, which includes a screen of the display 1 are shown. In other words, the expanded surface area 15 includes the display screen of the display 1 as a region of the expanded surface area 15. The user, e.g. a driver of the ego-vehicle, observes an object 3 in the environment of the ego-vehicle.

The user location 19 in FIG. 9 corresponds to an eye location of the user, for example. The target object 3 corresponds to a shape detected by the sensor, and may be included as a mesh or point cloud in the sensor data provided by the at least one sensor. The system generates projection rays 16.1, 16.2, 16.3 from edges or vertices of the detected shape corresponding to the object 3 in the environment to the user location (observer origin). A projection 2D image 17 of the detected shape using the projection rays 16.1, 16.2, 16.3 on the expanded surface 15 provides the shape or outline of the object representation 3′ displayed on the display 1 corresponding to the object 3 in the real world. Using the shape of the projection 2D image 17 for the object representation on the display 1 increases to probability of the user making an intuitive association of the object representation 3′ on the display 1 with the object 3 in the real world, due to a resemblance in the outward appearance from the position of view of the user.

The inset figure in the lower portion of FIG. 9 further illustrates that the origin of the projection used for generating the shape of the object representation 3′ may be the location of the user, e.g. the driver of the ego-vehicle. Alternatively, the system may use another location may be used as a reference point, e.g. a center point of the ego-vehicle, provided there is an offset Δz along the z-axis between the reference point and the display screen of the display 1.

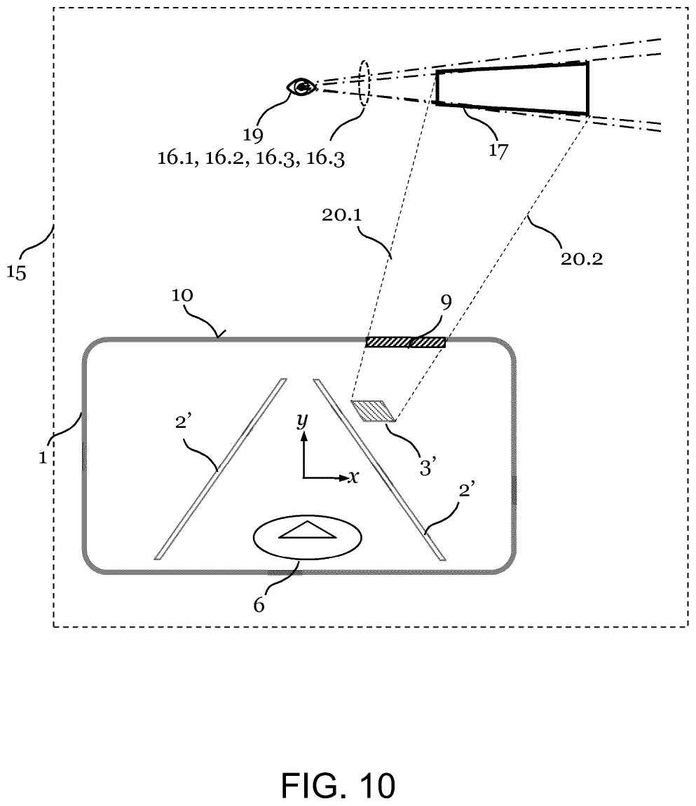

FIG. 10 is an illustration for explaining a method for generating the indicator bar 9 along an edge of the display 1.

The display 1, in particular a display screen of the display 1, determines the expanded surface 15 as discussed with reference to FIG. 9. The expanded surface 15 extends along an x-axis and a y-axis and includes the display 1. The projection 2D image 17 of the detected shape of an object 3 in the environment of the display 1 is not explicitly shown in FIG. 10. Via the projection rays 16.1, 16.2, 16.3, the shape of the object 3 in the real world is projected on the expanded surface 15 using the user location 19. The user location 19 may be an eye location of the eyes of the user.

The method generates the object representation 3′ displayed on the display 1 corresponding to the object 3 in the reals world as discussed before.

In the embodiment of FIG. 10, the method generates the indicator 9 along an edge of the display 1 as extending from a first intersection point of a first connecting line 20.1 to with the edge 10 of the display 1 to a second intersection point of a second connecting line 20.2. The first connecting line 20.1 corresponds to a line in the expanded surface 15, which connects a leftmost point of the object representation 3′ with a leftmost point of the projection 2D image 17. The second connecting line 20.1 corresponds to a line in the expanded surface 15, which connects a rightmost point of the object representation 3′ with a rightmost point of the projection 2D image 17.

The first and the second intersection points represent a starting point and an end point of the indicator bar 9.

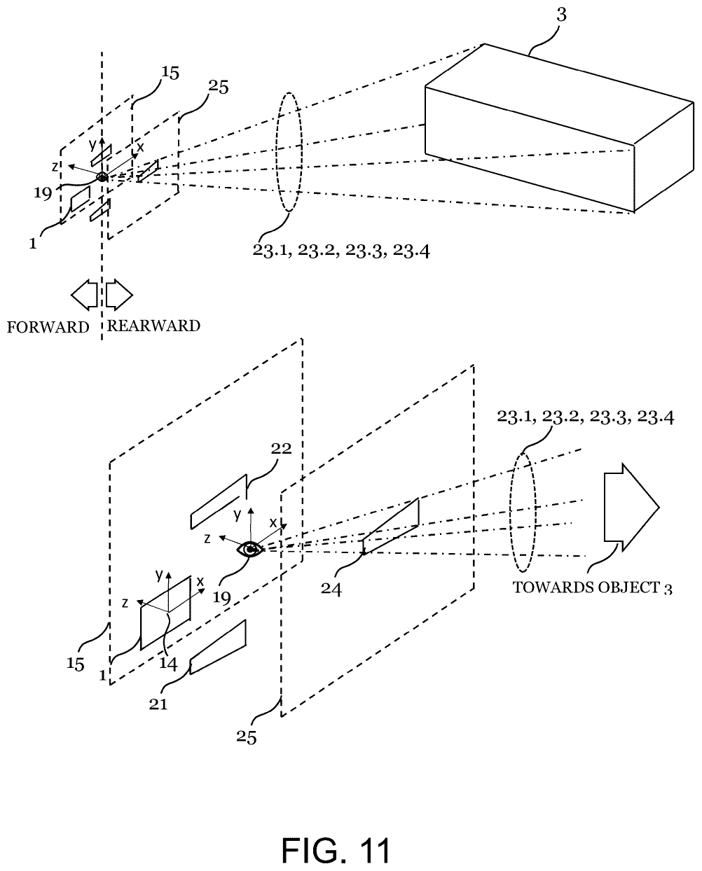

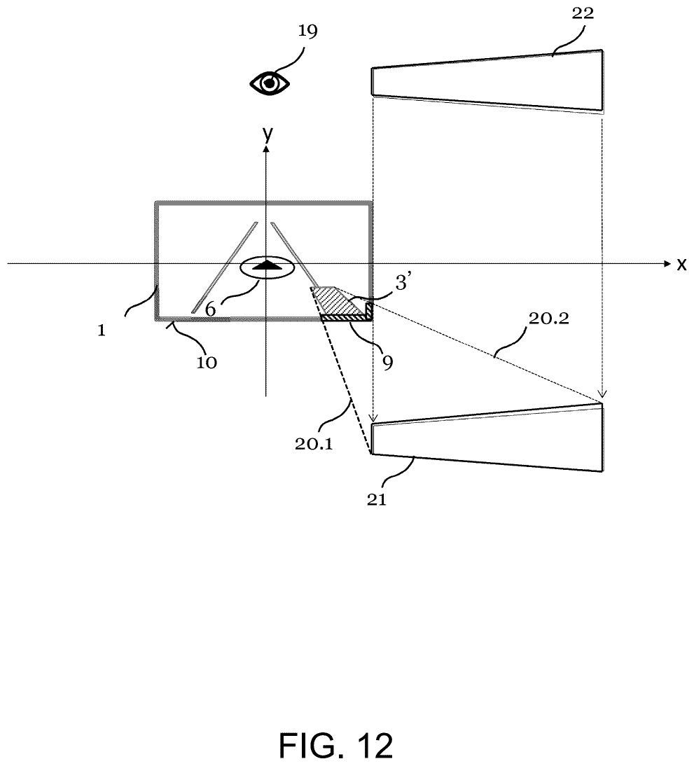

FIG. 11 is an illustration for explaining a method for determining the display 1 including representations for objects 3, 5 corresponding to real-world objects 3, 5 located in the rear of an ego-vehicle. An exemplary screen display on the display 1 for an object located to the rear of the ego-vehicle is discussed with reference to FIG. 12.

When discussing FIG. 11 as well as FIG. 12, objects 3, 5 that are located in a positive direction of the z-axis of the location of the user are considered to be located in a forward direction of the ego-vehicle or essentially in a forward driving direction of the ego-vehicle. Objects 3, 5 that are located in a negative direction of the z-axis of the origin of the coordinate system of the display 1 are considered to be located in a rear direction of the ego-vehicle or essentially in a rear driving direction of the ego-vehicle. The calculations presented with regard to the embodiment of FIGS. 11 and 12 illustrate the possibility to generate a representation of the environment on the display 1 that provides the user with an intuitive understanding of the environment around the ego-vehicle, which is not restricted to a frontal partial sphere, but also present information on the other directions in a manner easily and intuitively to grasp.

In order to generate a display for objects located to the rear of the ego-vehicle, the expanded surface 15 (first expanded surface 15) including the display 1 is mirrored along an x-y-plane that includes the user location 19, in particular an eye location of the user, for generating the mirrored expanded surface 25 (second expanded surface 25). Then, a projected 2D image 24 of the object 3 located to the rear of the user location 19 is generated on the mirrored expanded surface 25 by a projection using the user location 19.

Then, the projected 2D image 24 of the object 3 in the mirrored expanded surface 25 is mirrored at the x-y-surface that includes the user location onto the expanded surface 15 to generate a first mirrored projected outline 22 located on the expanded surface 15.

The first mirrored projected outline 22 located on the expanded surface 15 is then flipped (mirrored) along an x-axis in the origin 14 of the coordinate system corresponding to the center of the display 1 to generate the second mirrored projected outline 21. The second mirrored projected outline 21 corresponding to the object 3 in the real world forms then the basis for generating a display 1 that also includes an object representation 3′ and an indicator bar 9 associated therewith as shown in FIG. 12.

FIG. 12 is an illustration of determining a display content including an object representation 3 ‘for an object 3 corresponding to a real-world object 3 located in the rear of the ego-vehicle. Generating the object representation 3’ and the associated indicator bar 9 in FIG. 12 may be performed in an analogous manner as discussed with reference to FIG. 10, replacing the projection 2D image 17 of FIG. 10 with the second mirrored projected outline 21 in FIG. 12.

The second mirrored projected outline 21 enables to generate the indicator bar 9 extending along a lower edge 10 of the display 1 indicating the object 3 located to the rear of the ego-vehicle.

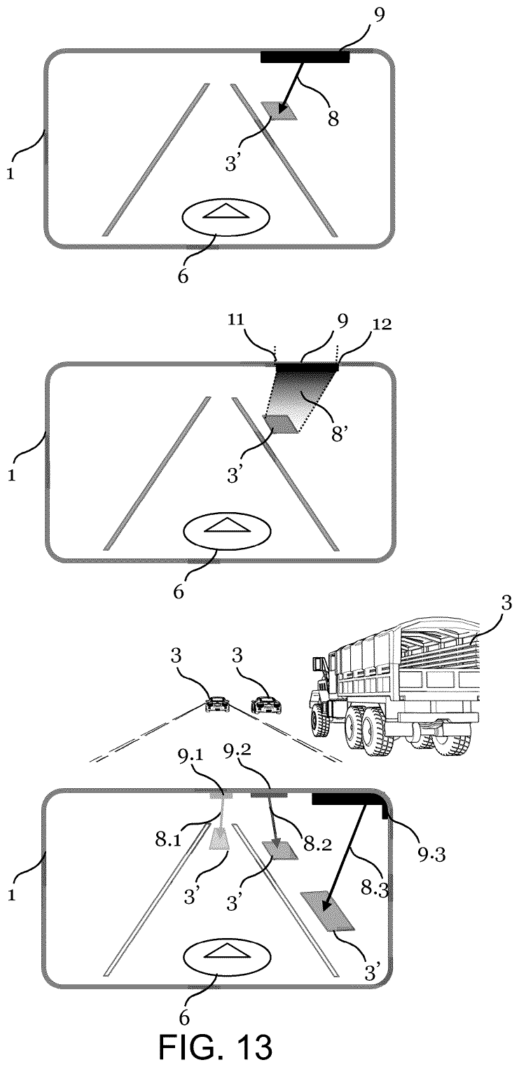

FIG. 13 is an illustration of the display 1 allowing to easily recognizing the correspondence between real-world objects 3 and their representation 3′ on the display 1 using variations of the indicator line 8 and the indicator bars 9.

In the upper part of FIG. 13, the display 1 depicts a representation of a road traffic scenario including a single object 3, which is represented in the display 1 by an object representation 3′. As discussed with respect to previous embodiments, an indicator bar 9 extends along the outer edge 10 of the display 1. The indicator line 8 connecting the indicator bar 9 with the object representation 3′ has the form of an arrow starting at a starting point 7 at the center of the indicator bar 9 and extending towards a center of the object representation 3′ on the display 1.

In the center part of FIG. 13, an alternate format of the indicator line 8′ is shown. The indicator line 8′ connecting the indicator bar 9 with the object representation 3′ has the form of an area starting at the end points 11, 12 of the indicator bar 9 and extending towards the object representation 3′ on the display 1. In the specific example of the indicator line 9′, the indicator line 8′ or indicator area 8′ has a color gradient starting with full color shading at the indicator bar 9 and gradually reducing the brightness of the color shading towards the object representation 3′. The example of the display 1 enables the user viewing the display 1 to easily recognize the association of the indicator bar 9 at the edge of the display 1 with the corresponding object representation 3′ shown on the display 1, and is particularly advantageous for use with representations of densely populated traffic and dynamically changing traffic scenarios.

In the lower part of FIG. 13, an embodiment of the assistance system uses a display 1 for a traffic scenario in the environment that includes a plurality of objects 3. The objects 3 are located at different distances from the ego-vehicle mounting the assistance system. In the example illustrated in the lower part of FIG. 13, a width of the indicator bar 9.1, 9.2, 9.3 and the color shading of the color filling of the indicator bar 9.1, 9.2, 9.3 encodes a distance of the respective object 3 from the ego-vehicle. Alternatively or additionally, and shown in the lower part of FIG. 12, the indicator line 8.1, 8.2, 8.3 may encode the distance of the distance of the respective object 3 from the ego-vehicle.

For example, assistance system determines the color shading of the respective indicator bar 9.1, 9.2, 9.3 and indicator line 8.1, 8.2, 8.3 to be the lighter the more distant the corresponding object 3 in the real world is located from the display 1.

In the present invention it is very easy for a user of the display 1 to identify real-world objects with corresponding icons or other illustrations of the real-world objects displayed on the display 1. Thus, the time needed by the user in order to consider all relevant information for successfully and correctly assessing for example a traffic situation in dynamic environments is significantly reduced. A detrimental effect of providing additional information is thus avoided.

The preferred field of application is an integration in advanced driver assistance systems or, more general, assistance systems used in vehicles. Such systems could be using onboard mounted sensors and displays. However, standalone solutions may also be thought of. For example, a handheld device used for navigation could be equipped with respective sensors so that even such a standalone device could make use of the present invention. The latter could be great improvement of safety for pedestrians which tend to look on their mobile devices when navigating towards an unknown destination. The present invention objects perceived in the corner of the eye may easily be identified with the corresponding icons on the display. Even without looking up in order to obtain complete information on this specific object in the real world, the pedestrian may make at least a basic estimation regarding the relevance of the respective real-world object.

Specifically the combination of the indicator lines with the indicator bars allow an identification of the real-world objects with a glimpse of an eye. Calculating the surface areas as explained in detail about, all running through the origin of the coordinate system of the display 1 and thus through the reference point of the display 1, results in scaling the dimensions of the real-world objects on the edge of the display 1 which is intuitively recognized as the boundary between the “virtual world” and the “real world” using the indicator bars.

What is claimed is:

1. A method for assisting a user of an assistance system including at least one sensor to sense an environment, a processor, and a display for displaying representations of one or more objects in the environment of the display, comprising the following method steps:
obtaining, from the at least one sensor, information on the environment of the display;
determining, by the processor, presence of objects in the environment;
displaying, on the display, a representation of the environment including the user, and the objects determined in the environment, wherein real world positions of the user and the at least one object are converted into a coordinate system of the display;
determining, by the processor, for at least one of the objects represented in the representation of the environment, a starting point for an indicator line from a direction of the at least one object relative to the display; and
displaying, on the display, for each determined starting point, the indicator line connecting the starting point with the displayed representation of the at least one object.

2. The method according to claim 1, wherein
the reference point of the display corresponds to a center of the display, a representation of the user displayed by the display, a center of an ego-vehicle, or an eye location of the user in the coordinate system of the display.

3. The method according to claim 1, wherein
the starting point is calculated as a point of intersection between an outer edge of the display and a surface area extending from a vertical axis y through a reference point of the display and including a direction vector pointing from the reference point towards the at least one object for which the indicator line shall be displayed.

4. The method according to claim 3, wherein
the direction vector is calculated as pointing from the reference point in the display to a center of the at least one object.

5. The method according to claim 1, wherein
for the at least one object an indicator bar corresponding to a scaled horizontal extension of the at least one object is displayed along the outer edge of the display, wherein the indicator bar includes the starting point.

6. The method according to claim 2, wherein
for the at least one object an indicator bar corresponding to a scaled horizontal extension of the at least one object is displayed along the outer edge of the display, wherein the indicator bar includes the starting point.

7. The method according to claim 3, wherein
for the at least one object an indicator bar corresponding to a scaled horizontal extension of the at least one object is displayed along the outer edge of the display, wherein the indicator bar includes the starting point.

8. The method according to claim 5, wherein
for the at least one object an indicator bar corresponding to a scaled horizontal extension of the at least one object is displayed along the outer edge of the display, wherein the indicator bar includes the starting point.

9. The method according to claim 8, wherein
the indicator bar includes a visual characteristic for indicating a determined characteristic of the at least one object.

10. The method according to claim 6, wherein
the indicator bar extends from an intersection point of the edge of the display and a first boundary surface area to an intersection point of the edge of the display and a second boundary surface area, wherein the first boundary surface area extends from the vertical axis y through the reference point and includes a direction vector pointing from the reference point towards a first outermost perceivable boundary of the at least one object in the horizontal direction and the second boundary surface area extends from the vertical axis through the reference point and includes a direction vector pointing from the reference point towards an opposite, second outermost perceivable boundary of the at least one object in the horizontal direction.

11. The method according to claim 10, wherein
the indicator line is an area with a width extending from the first boundary area to the second boundary area, wherein a visual characteristic of the indicator line includes a predetermined color, a gradient color, or a predetermined pattern.

12. The method according to claim 10, wherein,
in case of coincidence of boundary surface areas of two determined objects, the directly adjacent indicator bars are displayed using distinguishable characteristics.

13. The method according to claim 1, comprising
determining shapes of the representations of the objects by projecting, using an eye position of the user, a shape of each of the objects into an expanded surface including the display screen, and respectively generating the shape of the representations based on the projected shapes of the objects.

14. The method according to claim 1, comprising
determining shapes of the representations of the objects located to a rear of the user by performing steps of
projecting, using a position of the user, a shape of each of the objects located to the rear into a mirrored expanded surface to generate a projected shape, wherein the mirrored expanded surface is a surface generated by mirroring the expanded surface including the display screen,
mirroring the projected shape to the expanded surface including the display screen at a surface that includes the eye position of the user and is in parallel with the mirrored expanded surface and the expanded surface including the display screen to generate a first reflected shape,
mirroring the first reflected shape along a horizontal axis running through a center of the display to generate a second reflected shape in the expanded surface including the display screen, and
respectively generating the shape of the representations of the objects located to the rear based on the second reflected shapes of the objects located to the rear.

15. An assistance system comprising at least one sensor, a processor, and a display controlled by the processor, wherein the at least one sensor is configured to sense an environment of the vehicle, and wherein the processor is configured to:
obtain from the at least one sensor, information on an environment of the display;
determine presence of at least one object in the environment of the display;
cause the display to display a representation of the environment including the user and the at least one object, wherein real world positions of the user and the at least one object are converted into a coordinate system of the display;
determine for at least one of the objects represented in the representation of the environment, a starting point for an indicator line from a direction of the at least one object relative to the display; and
cause the display to display the indicator line connecting the starting point with the displayed representation of the at least one object.

16. An assistance system according to claim 15, wherein
the processor is further configured to cause the display to display for the at least one object an indicator bar corresponding to a perceivable horizontal extension of the at least one object along the outer edge of the display, wherein the indicator bar includes the starting point.

17. A vehicle comprising the assistance system according to claim 15.

18. A vehicle comprising the assistance system according to claim 16.
